(19) United States
(12) Patent Application Publication
(10) Pub. No.: US 2026/0125505 A1
(43) Pub. Date: May 7, 2026

(54) METHOD FOR REALIZING LIVING/CONTROLLED FREE RADICAL POLYMERIZATION OF HYDROPHILIC AND/OR HYDROPHOBIC MONOMERS UNDER AIR CONDITIONS

(71) Applicant: HENAN NORMAL UNIVERSITY, Xinxiang (CN)

(72) Inventors: Chunna LYU, Xinxiang (CN); Mengyao DU, Xinxiang (CN); Xiangcheng PAN, Shanghai (CN); Guowei WANG, Shanghai (CN); Zhiguo HU, Xinxiang (CN); Congcong CUI, Shanghai (CN)

(21) Appl. No.: 19/021,863

(22) Filed: Jan. 15, 2025

(30) Foreign Application Priority Data
Nov. 4, 2024 (CN) 202411560341.4

(51) Int. Cl. C08F 293/00

(52) U.S. Cl. CPC C08F 293/005; C08F 2438/01

(57) ABSTRACT

A method for realizing living/controlled free radical polymerization of hydrophilic and/or hydrophobic monomers under air conditions is provided. The functional monomer including hydrophobic monomer, halide, copper bromide, ligand and non-ionic surfactant-GOx is used to initiate the polymerization of monomer in a solvent through initiator azodiisobutyric imidazoline hydrochloride (VA-044) to form polymer with narrow target molecular weight and molecular weight distribution.

### CROSS-REFERENCE TO RELATED APPLICATIONS

This application claims priority to Chinese Patent Application No. 202411560341.4, filed on Nov. 4, 2024, the contents of which are hereby incorporated by reference.

### TECHNICAL FIELD

The disclosure belongs to the technical field of living/controlled free radical polymerization, in particular to a method for realizing living/controlled free radical polymerization of hydrophilic and/or hydrophobic monomers under air conditions.

### BACKGROUND

Glucose oxidase (GOx) oxidizes glucose into D-gluconic acid-δ-lactone by consuming O₂ and produces hydrogen peroxide at the same time, and realize the deoxidation of living/controlled free radical polymerization. However, in GOx-assisted living/controlled free radical polymerization, the range of applicable monomers is limited to water-soluble monomer only. Therefore, it is urgent to expand a wide range of monomers.

### SUMMARY

The technical problem solved by the disclosure is to overcome the existing defects and provide a living/controlled free radical polymerization method to realize the selection of a wide range of monomer including hydrophobic monomer under air conditions. The atom transfers radical polymerization (ATRP) of hydrophobic monomer is carried out by deoxidation of living/controlled free radical polymerization with non-ionic surfactant-GOx, which can not only realize the polymerization of hydrophobic monomer, but also improve the conversion rate of hydrophobic monomer, greatly broaden the application scope of monomer, and find a new polymerization method for living/controlled free radical polymerization of hydrophobic monomer.

The technical problem to be solved by the disclosure is to overcome the existing defects and provide a method for realizing living/controlled free radical polymerization of hydrophilic and/or hydrophobic monomers under air condition, and can effectively solve the problems in the background technology.

In order to achieve the above objectives, the disclosure provides a method for realizing living/controlled free radical polymerization of hydrophilic and/or hydrophobic monomers under air conditions, which adopts the technical scheme including following steps:
step 1, dissolving functional monomer, initiator, metal halide, ligand and glucose oxidase modified by non-ionic surfactant in a solvent; the functional monomer is at least one of water-soluble monomer and hydrophobic monomer; and
step 2, carrying out a polymerization reaction by continuous stirring at 45° C. for 12-24 h under closed conditions, and a reaction equation is as follows:

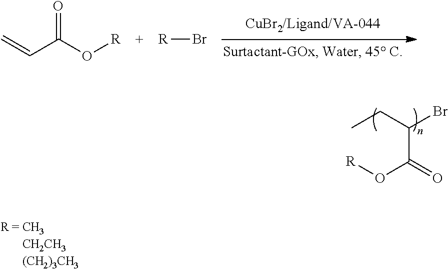

As an optional technical scheme of the disclosure, the functional monomer includes acrylic acid, methyl acrylate (MA), ethyl acrylate (EA), tert-butyl acrylate ((BA), n-butyl acrylate (nBA), glycidyl methacrylate ether, methyl methacrylate (MMA) and polyethylene glycol monomethyl ether methacrylate (OEOMA₅₀₀). A structural formula of some monomers is as follows:
A) hydrophobic monomer

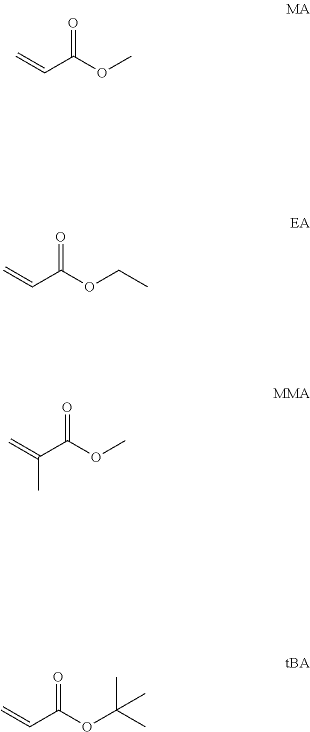

B) water-soluble monomer

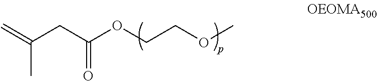

As an optional technical scheme of the disclosure, the ligand is one or more among tri [2-(dimethylamino)ethyl]amine (Me₆TREN), tri (2-pyridinemethyl) amine (TPMA), 2,2′-bipyridine (bpy), N, N,N′N′ nn-tetramethylethylenediamine (PMDTEA). Among them, Me₆TREN and TPMA are high-activity ligands, while bpy and PMDTEA are low-activity ligands, and their structural formulas are as follows:

High-activity

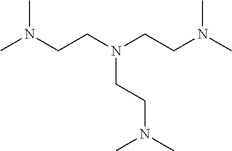

Me₆TREN

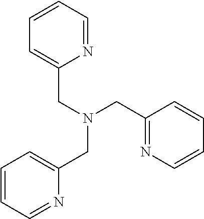 [SMILES: c1ccc(CN(Cc2ccccn2)Cc2ccccn2)nc1]

TPMA
Low-activity

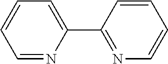 [SMILES: c1ccc(-c2ccccn2)nc1]

bpy

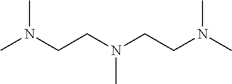

PMDTEA

As an optional technical scheme of the disclosure, a preparation method of glucose oxidase modified by non-ionic surfactant is as follows:

firstly, higher alcohol reacts with L-glutamic acid to obtain an intermediate product, then the intermediate product reacts with glucose to obtain glucosyl-1-glutamic acid diester and its derivative, and then the glucose oxidase (GOx) is modified with the derivative(S) of glucosyl-1-glutamic acid diester to obtain the target product of glucose oxidase (S-GOx) modified with non-ionic surfactant; and a reaction equation is as follows:

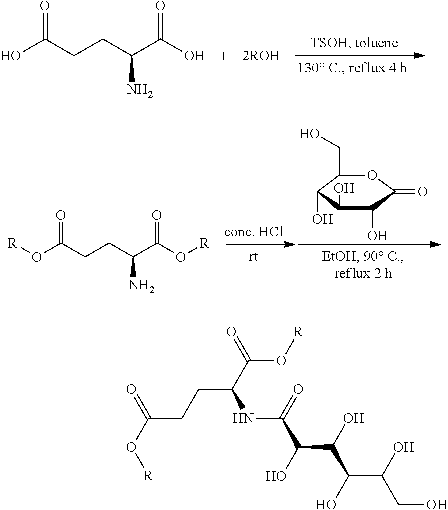

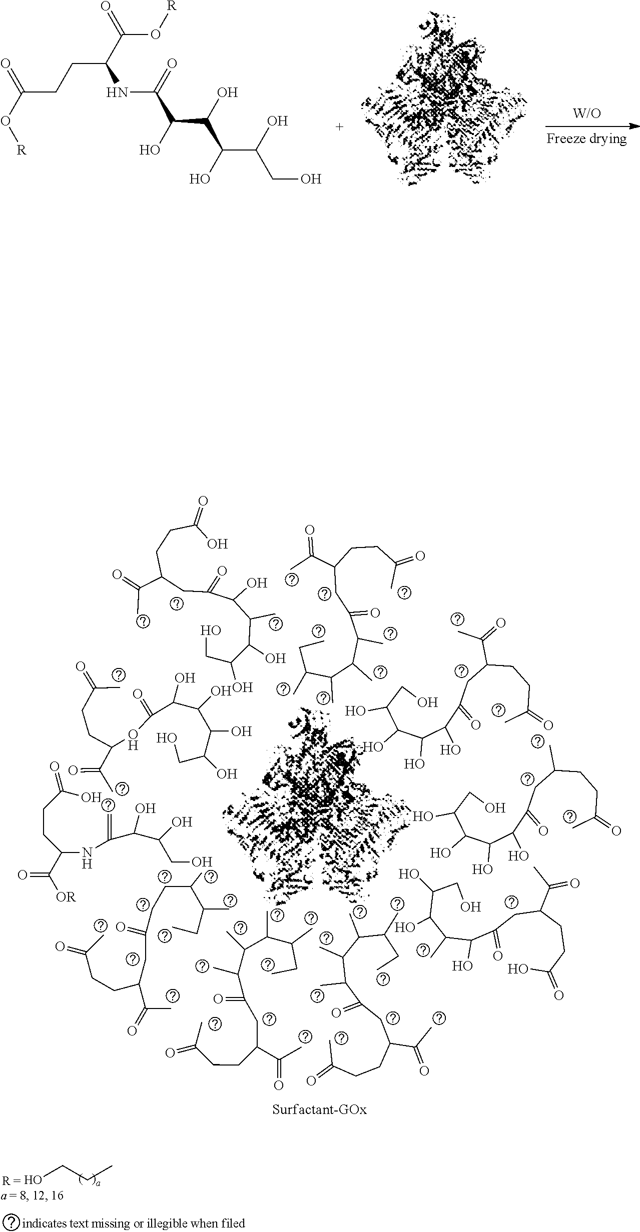

where the higher alcohol is n-decanol, tetradecanol or octadecanol. S-GOx may not only deoxygenate hydrophobic monomer, but also control the hydrophobic monomer to react with copper bromide, ligand and initiator within a certain range, so as to realize precise control of polymerization conditions, fine regulation of polymer molecular weight, molecular weight distribution, microstructure and macro-property. The precise control not only meets the strict requirements for material properties in specific applications, but also improves the consistency and reliability of products.

As an optional technical scheme of the disclosure, the initiator includes a first initiator and a second initiator, where the first initiator is one or more among 2-bromoethyl isobutyrate and its halide; the second initiator is azodiisobutyl imidazoline hydrochloride (VA-044).

As an optional technical scheme of the disclosure, the molar ratio of the functional monomer, the metal halide, the first initiator, the ligand, the glucose oxidase modified with non-ionic surfactant and the second initiator is x/1/0.6/2.4/2.0/6.0, where the value of X is 50-600 determined by the degree of polymerization, that is, the ratio of monomer and the first initiator.

As an optional technical scheme of the disclosure, the metal halide is copper bromide.

As an optional technical scheme of the disclosure, in the step 2, the mixture is stirred stably at 45° C. for 12-24 h.

The disclosure also provides the application of the method for realizing living/controlled free radical polymerization of hydrophilic and/or hydrophobic monomers under air conditions in preparing waterborne coatings and adhesives.

Compared with the prior art, the disclosure has the beneficial effects: the glucose oxidase is modified by using a surfactant, so the hydrophobic monomer may be deoxygenated, thereby increasing the stability and solubility in an anhydrous medium and widening the selection range of monomers. The glucose oxidase used in the polymerization method provided by the disclosure is low in price and environmentally friendly, and consumes oxygen in the system. The method has the advantages of mild reaction conditions, easy realization, simple reaction operation, rapid and efficient polymerization reaction without complicated deoxygenation operation, and can realize the polymerization of hydrophobic monomers, and the conversion rate may reach more than 99% within 12 h; and the target molecular weight of the product is controllable and the polydispersity is narrow.

### BRIEF DESCRIPTION OF THE DRAWINGS

FIG. 1 is a proton nuclear magnetic resonance spectrum of ligand TPMA of the present disclosure.

FIG. 2 is a proton nuclear magnetic resonance spectrum of glucosyl-1-glutamic acid diester of the present disclosure.

FIG. 3 is a proton nuclear magnetic resonance spectrum of a glucosyl-1-glutamic acid diester derivative of the present disclosure.

FIG. 4 is a comparison diagram of the activity of S-GOx obtained by using different higher alcohols in the present disclosure.

FIG. 5 is a GPC spectrum of methyl polyacrylate with target polymerization degree synthesized in Embodiment 1 of the present disclosure.

FIG. 6 shows the ATRP reaction of hydrophobic monomer methyl acrylate in air and the proton nuclear magnetic resonance spectrum of the product after chain extension.

FIG. 7 is the GPC spectrum of methyl polyacrylate with the target polymerization degree and its self-extending chain products synthesized by the present disclosure.

### DETAILED DESCRIPTION OF THE EMBODIMENTS

In the following, the technical scheme in the embodiment of the disclosure will be clearly and completely described with reference to the attached figures. Obviously, the described embodiments are only a part of the embodiments of the disclosure, but not all embodiments. Based on the embodiments in the present disclosure, all other embodiments obtained by ordinary technicians in the field without creative labor belong to the scope of protection of the present disclosure.

### Embodiment 1

This embodiment discloses the first embodiment of the disclosure, adopting a technical scheme including following steps:

step 1, ligand TPMA is synthesized.

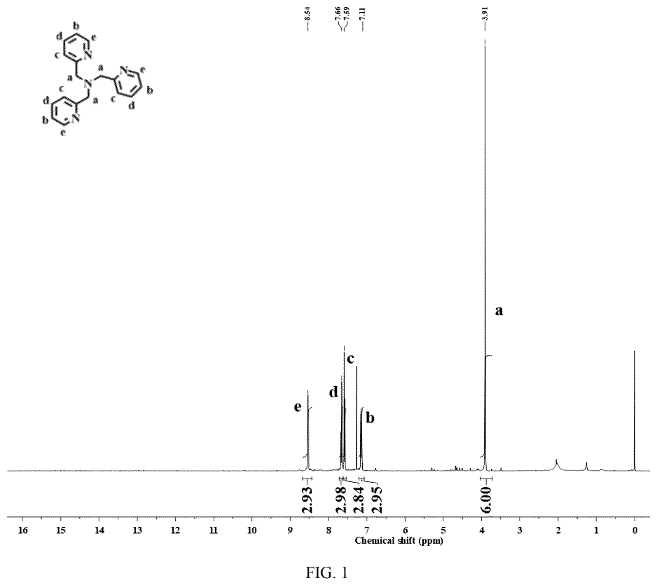

In a 250 mL round-bottomed flask, 2-(chloromethyl)pyridine hydrochloride (30.6 mmol, 5.02 g), anhydrous sodium carbonate (300.2 mmol, 31.83 g), anhydrous acetonitrile (100 mL) are added, covered with a rubber stopper. Then 2-(aminomethyl)pyridine (15 mmol, 1.63 g) is dissolved in 50 mL of anhydrous acetonitrile and added into the reaction flask drop by drop under Ar₂ atmosphere, and the reaction mixture is stirred steadily for 30 min under Ar₂ atmosphere, and then refluxed for 12 h at 90° C. under Ar₂ atmosphere. At the end of the reaction, the white precipitate is removed by filtration, followed by spinning to remove the acetonitrile, and the resulting solid is extracted three times repeatedly with 60 mL of dichloromethane to obtain the organic phase. After removal of the dichloromethane, the organic phase is recrystallized in hot acetone to obtain a yellow solid, and the structure is characterized by ¹H NMR, and the results are shown in FIG. 1 (vertical coordinates show intensities).

Step 2, non-ionic surfactant gluconyl-1-glutamic acid diester is prepared.

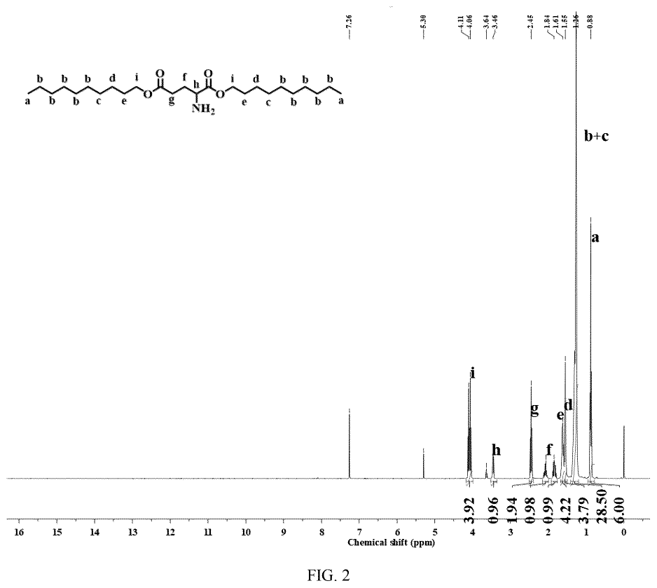

The mixture of L-glutamic acid, n-decanol and p-toluenesulfonic acid (molar ratio is 1:2:1) is refluxed in toluene solution at 120° C. for 4 h. Then, it is cooled to room temperature, toluene is removed under reduced pressure, and the reaction mixture is neutralized with 10% sodium bicarbonate solution. Then the aqueous phase is extracted with ethyl acetate, if the emulsification is serious during the reaction, the organic phase is extracted with 10% sodium bicarbonate and saturated sodium chloride solution. After the extraction, a large amount of anhydrous magnesium sulfate is added for drying, the white solid is removed by suction filtration with a Buchner funnel, vacuum concentration is carried out under reduced pressure, and then silica gel column chromatography is carried out for purification. First, the raw material n-decanol is passed out with DCM, and then the column is flushed twice with DCM:MeOH=60:1. Finally, the product is obtained by DCM:MeOH=30:1 and concentrated in vacuum to obtain a pale yellow liquid, and the structure is characterized by ¹H NMR. The result is shown in FIG. 2 (the ordinate shows the signal intensity).

Step 3, a derivative(S) of non-ionic surfactant gluconyl-1-glutamic acid diester is prepared.

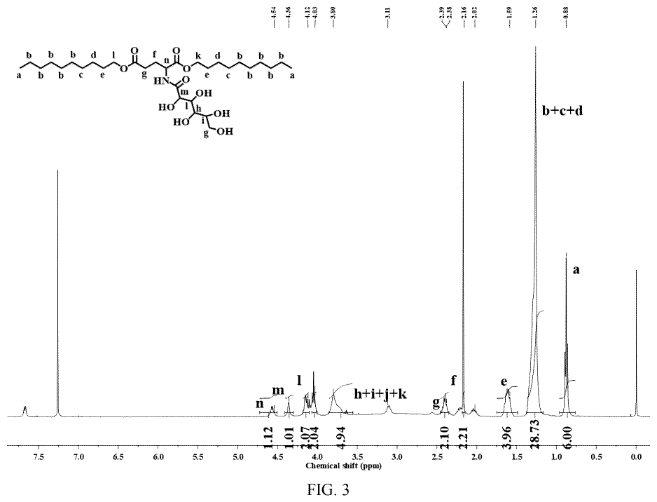

Hydrochloric acid is added to the yellowish liquid obtained in Step 2 to form a salt (white viscous solid), and this salt is recrystallized in acetone to obtain a white solid; next, a mixture of the solid salt, gluconolactone, and triethylamine (the molar ratio is 1:1:1) is refluxed in ethanol for 2 h. The solvent is removed under reduced pressure, after which the crude product is recrystallized in acetone to obtain the target, S, which is characterized for its structure by ¹H NMR. The results are shown in FIG. 3 (vertical coordinates show signal intensity).

Step 4, non-ionic surfactant glucosyl-1-glutamic acid dioleate derivative-glucose oxidase (S-GOx) is prepared.

The white solid (0.15 mmol) obtained in Step 3 is dissolved in 30 mL of toluene, and then the dissolved mixture is dissolved with glucose oxidase (0.5 mmol) in 10 mL of PBS buffer solution, and then dialyzed in a shaker at 1500 rpm for 12 h. After 12 h, a white powder is obtained by freeze-drying, i.e., the target product S-GOx.

Step 5, ATRP reaction is carried out under air using the hydrophobic monomer methyl acrylate.

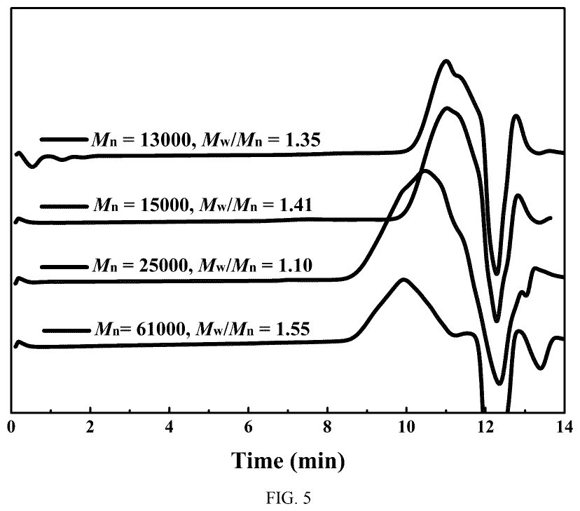

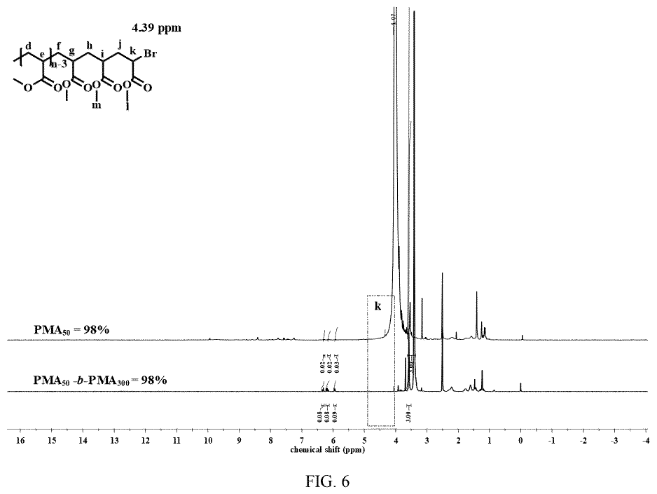

Methyl acrylate (MA, 0.86 g, 10 mmol), 2-ethyl isobutyrate bromide (0.0058 g, 0.03 mmol), copper bromide (0.0046 g, 0.02 mmol), VA-044 (0.064 g, 0.2 mmol), ligand (TPMA, 0.0232 g 0.08 mmol) and S-GOx (0.084 g, 0.08 mmol) prepared in Step 4 are placed in a 5 mL round bottomed flask, sealed with a glass stopper using PBS buffer solution (0.08 mmol, 2.5 g) as a solvent, and wrapped with a sealing film to make the whole system in a closed state, and the reaction mixture is stirred smoothly at 45° C. for 24 h. After the reaction, a few samples are taken to calculate the monomer conversion rate of 99.2%, and the structure of the polymer is characterized by ¹H NMR. The results are shown in the first segment of FIG. 6, and the GPC spectrum of the polymer is shown in FIG. 5 (the vertical ordinates show the signal intensity).

### Embodiment 2

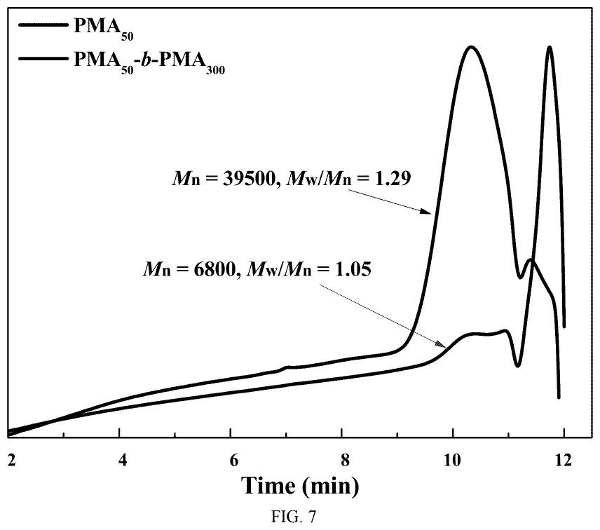

The difference between Embodiment 2 and Embodiment 1 is that during the ATRP reaction, the reaction mixture is stirred stably at 45° C. for 12 h, and after the reaction, a few samples are taken to calculate the monomer conversion rate of 80%. Then, additional PBS buffer solution (0.08 mmol, 2.5 g), methyl acrylate (0.8609 g, 10 mmol) and VA-044 (0.064 g, 0.2 mmol) are added to the reaction mixture for chain extension, and then S-GOx (0.084 g, 0.08 mmol) is added for polymerization. After 12 h, a few samples are taken out to calculate the monomer conversion rate of 99.7%, and the structure of the polymer is characterized by ¹H NMR. The results are shown in the second segment of FIG. 6, and the GPC spectrum of the polymer is shown in FIG. 7 (the vertical ordinates show the signal intensity).

### Embodiment 3

The difference between the Embodiment 3 and Embodiment 1 is that the hydrophobic monomer used in Step 5 is EA.

### Embodiment 4

The difference between the Embodiment 4 and Embodiment 1 is that the hydrophobic monomer used in Step 5 is nBA.

Comparing the ATRP polymerization products of Embodiments 1, 3 and 4, the results are as follows:

| | Molar ratio of dosage | | | | | |
|---|---|---|---|---|---|---|
| | (Monomer:EBiB:CuBr₂:TPMA:S- | Time | Conversion | | | |
| Group | GOx:VA-044) | (h) | rate (%) | M_{n, th} | M_{n, GPC} | M_{w}/Mₙ |
| Embodiment 1 | 300:1:0.6:2.4:2:6 | 12 | >99 | 26100 | 33000 | 1.37 |
| Embodiment 3 | 300:1:0.6:2.4:2:6 | 12 | 93 | 28100 | 38200 | 1.39 |
| Embodiment 4 | 300:1:0.6:2.4:2:6 | 12 | 20 | 7900 | 14000 | 1.02 |

From the above comparison, it can be seen that with the growth of the carbon chain of the group, the final conversion rate of ATRP polymerization gradually decreases, but the polydispersity coefficient first increases and then decreases. When nBA is used, although the conversion rate is low, the polydispersity coefficient approaches to 1, and the performance is relatively stable. When EA is used, the conversion rate is lower than that of MA monomer, while the polydispersity coefficient is higher, and the performance of the polymer is more significantly affected by intermolecular differences.

### Embodiment 5

The difference between the Embodiment 5 and Embodiment 1 is that the higher alcohol used in the preparation of the non-ionic surfactant gluconyl-1-glutamic acid diester in the Step 2 is tetradecanol.

### Embodiment 6

The difference between the Embodiment 6 and Embodiment 5 is that the hydrophobic monomer used in the Step 5 is EA.

### Embodiment 7

The difference between this Embodiment and Embodiment 5 is that the hydrophobic monomer used in the Step 5 is nBA.

Comparing the ATRP polymerization products of Embodiments 5, 6 and 7, the results are as follows.

| | Molar ratio of dosage | | | | | |
|---|---|---|---|---|---|---|
| | (Monomer:EBiB:CuBr₂:TPMA:S- | Time | Conversion | | | |
| Group | GOx:VA-044) | (h) | rate (%) | M_{n, th} | M_{n, GPC} | M_{w}/Mₙ |
| Embodiment 5 | 300:1:0.6:2.4:2:6 | 12 | >99 | 26000 | 44900 | 1.41 |
| Embodiment 6 | 300:1:0.6:2.4:2:6 | 12 | >99 | 31000 | 66800 | 1.85 |
| Embodiment 7 | 300:1:0.6:2.4:2:6 | 12 | 15 | 6000 | 13600 | 1.07 |

From the above comparison, it can be seen that with the growth of the carbon chain of the group, the final conversion rate of ATRP polymerization decreases, but the polydispersity coefficient first increases and then decreases. Although the conversion rate is low when using nBA, the polydispersity coefficient approaches 1, and the performance is relatively stable. However, when using EA, the polydispersity coefficient is higher, and the performance of the polymer is more affected by intermolecular differences.

### Embodiment 8

The difference between this Embodiment and Embodiment 1 is that the higher alcohol used in the preparation of non-ionic surfactant gluconyl-1-glutamic acid diester in the Step 2 is octadecyl alcohol.

### Embodiment 9

The difference between the Embodiment 9 and Embodiment 8 is that the hydrophobic monomer used in the Step 5 is EA.

### Embodiment 10

The difference between the Embodiment 10 and Embodiment 8 is that the hydrophobic monomer used in the Step 5 is nBA.

Comparing the ATRP polymerization products of Embodiments 8, 9 and 10, the results are as follows:

| | Molar ratio of dosage | | | | | |
|---|---|---|---|---|---|---|
| | (Monomer:EBiB:CuBr₂:TPMA:S- | Time | Conversion | | | |
| Group | GOx:VA-044) | (h) | rate (%) | M_{n, th} | M_{n, GPC} | M_{w}/Mₙ |
| Embodiment 8 | 300:1:0.6:2.4:2:6 | 12 | >99 | 26000 | 24000 | 1.51 |
| Embodiment 9 | 300:1:0.6:2.4:2:6 | 12 | >99 | 30000 | 39400 | 1.71 |
| Embodiment 10 | 300:1:0.6:2.4:2:6 | 12 | 23 | 9100 | 14300 | 1.01 |

From the above comparison, it is seen that with the growth of the carbon chain of the group, the final conversion rate of ATRP polymerization decreases, but the polydispersity coefficient first increases and then decreases. Although the conversion rate is lower when using nBA, it is higher than that of n-decanol and tetradecanol, and the polydispersity coefficient approaches to 1, so the performance is stable. However, when using EA, the polydispersity coefficient is higher, and the performance of the polymer is more significantly affected by intermolecular differences.

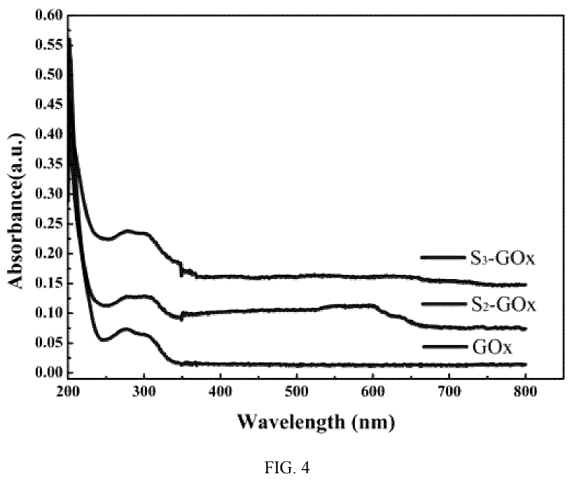

The enzymatic activity of S-GOx prepared with tetradecanol and octadecanol is shown in FIG. 4.

The VA-044 used in this disclosure is a commercially available product and belongs to the prior art.

Although embodiments of the present disclosure have been shown and described, it may be understood by those skilled in the art that various changes, modifications, substitutions and variations can be made to these embodiments without departing from the principles and spirit of the disclosure, the scope of which is defined by the claims and their equivalents.

What is claimed is:

1. A method for realizing living/controlled free radical polymerization of hydrophilic and/or hydrophobic monomers under air conditions, comprising following steps:
step 1, dissolving functional monomer, initiator, metal halide, ligand and glucose oxidase modified by non-ionic surfactant in a solvent; wherein the functional monomer is at least one among water-soluble monomer and hydrophobic monomer; and
step 2, carrying out a polymerization reaction by continuous stirring under closed and heating conditions, wherein a reaction equation is as follows:

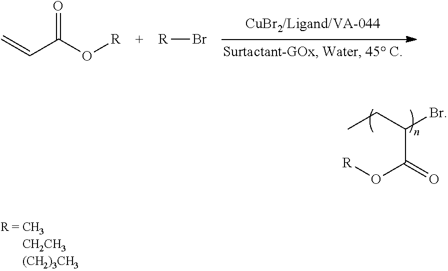

2. The method according to claim 1, wherein the functional monomer comprises acrylic acid, methyl acrylate, ethyl acrylate, tert-butyl acrylate, n-butyl acrylate, glycidyl methacrylate ether, methyl methacrylate and polyethylene glycol monomethyl ether methacrylate.

3. The method according to claim 1, wherein in the ligand is one or more among tris [2-(dimethylamino)ethyl]amine, tris (2-pyridinemethyl) amine, 2,2′-bipyridine and N, N, N′N′-tetramethylethylenediamine.

4. The method to claim 1, wherein a preparation method of glucose oxidase modified by non-ionic surfactant is as follows:
firstly, higher alcohol reacts with L-glutamic acid to obtain an intermediate product, then the intermediate product reacts with glucose to obtain glucosyl-1-glutamic acid diester and derivative of glucosyl-1-glutamic acid diester, and then the glucose oxidase is modified by using the derivative of glucosyl-1-glutamic acid diester; and a reaction equation is as follows: 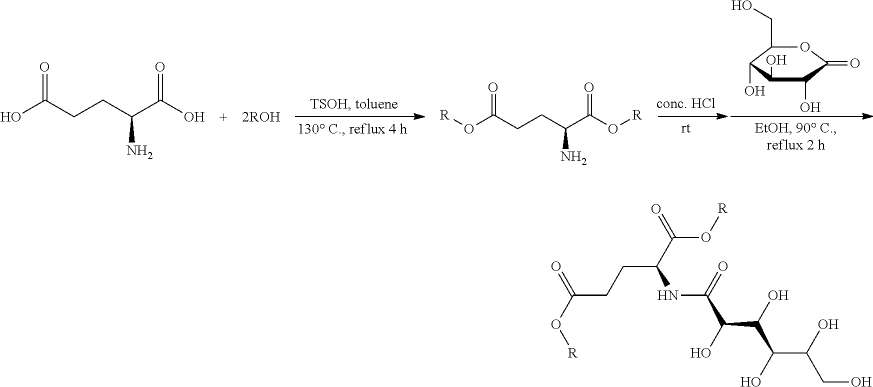 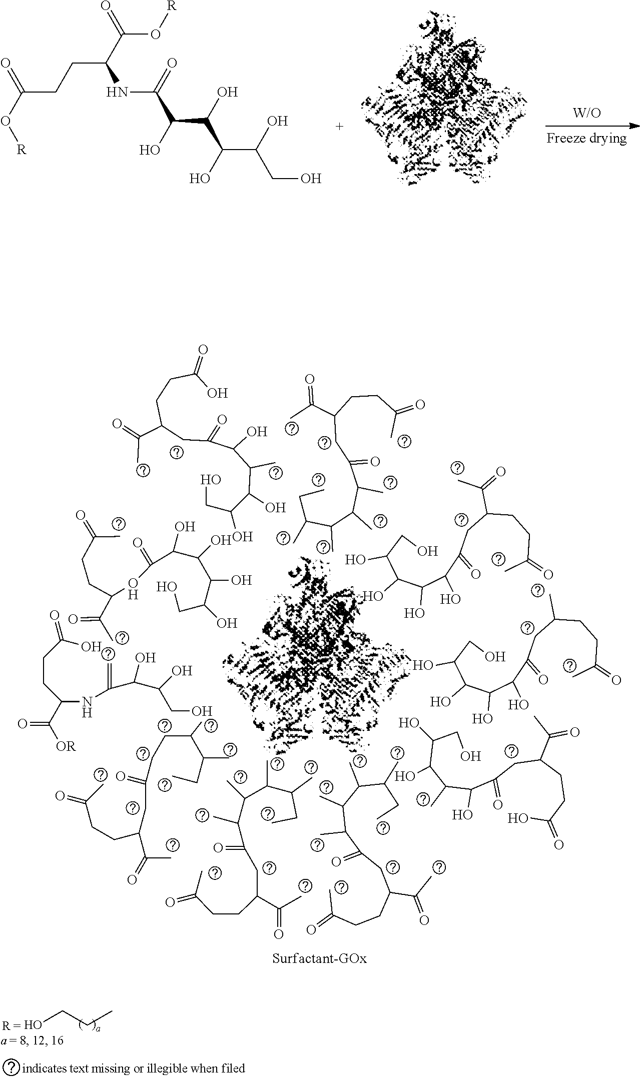
wherein the higher alcohol is n-decanol, tetradecanol or octadecanol.

5. The method according to claim 1, wherein the initiator comprises a first initiator and a second initiator, and the first initiator is one or more among 2-bromoethyl isobutyrate and its halide; and
the second initiator is azodiisobutyric imidazoline hydrochloride.

6. The method for realizing living/controlled free radical polymerization of hydrophilic and/or hydrophobic monomers under air condition according to claim 5, wherein a molar ratio of the functional monomer, the first initiator, the metal halide, the ligand, the glucose oxidase modified with non-ionic surfactant and the second initiator is x/1/0.6/2.4/0.6/2.0; and the value of x is 50-600 determined by a degree of the polymerization.

7. The method according to claim 1, wherein the metal halide is copper bromide.

8. The method according to claim 1, wherein in the step 2, a mixture is stirred smoothly at 45° C. for 12-24 h.
